(19) United States
(12) Patent Application Publication
(10) Pub. No.: US 2005/0224005 A1
(43) Pub. Date: Oct. 13, 2005

(54) Pep potty

(76) Inventor: Hwan-Ju Kim, Seoul (KR)

Correspondence Address: GREENBLUM & BERNSTEIN, P.L.C., 1950 ROLAND CLARKE PLACE, RESTON, VA, 20191, US

(21) Appl. No.: 10/511,275

(22) PCT Filed: Mar. 27, 2003
(86) PCT No.: PCT/KR03/00612

§ 371 Date: May 19, 2005

(30) Foreign Application Priority Data
Apr. 23, 2002 (KR) 1020020022137
Jan. 16, 2003 (KR) 1020030002896

(51) Int. Cl. A01K 29/00

(52) U.S. Cl. 119/163; 119/161

(57) ABSTRACT

The present invention relates to a pet potty capable of disposing of excrement of a pet. More particularly, the present invention relates to a pet potty that is automatically turned on when a built-in sensor detects a pet approaching the potty within a predetermined distance to evacuate excrement. When the pet finishes evacuating excrement and leaves the potty, the excrement is automatically disposed of by rotating the floor members. The potty is designed to be operated only when the pet stayed on the potty over a predetermined period of time. Thus the potty effectively prevent the troubles and uncleanness caused by the excrement of pets.

### TECHNICAL FIELD

The present invention relates to a pet potty capable of disposing of excrement of a pet. The present invention is an improved invention claiming priority based on Korean Patent Application No. 2002-22137 entitled “Pet Potty” and filed with the Korean Intellectual Property Office in the name of the present applicant. More particularly, the present invention relates to a pet potty which may detect a pet that approaches the pet potty by means of a sensor installed in the potty. When the pet finishes evacuating excrement and leave the potty, the potty automatically determines whether the pet has discharged urine or feces and disposes of the excrement. Thus, the potty may prevent the troubles and uncleanness caused by the excrement of pets.

### BACKGROUND ART

Generally, a pet such as a dog kept in a house is housebroken through repeated training by its owner so that the pet evacuates excrement only in a bathroom or a rest room that may be easily cleaned with water or on a plastic tray or mat placed in a living room. However, such a method has a problem in that the owner should always follow the pet and dispose of excrement of the pet or watch whether the pet evacuates excrement in a proper place.

Therefore, a variety of pet potties have been recently developed. Among them, a potable pet potty disclosed in Korean Utility Model Application No. 2001-38854 filed on Dec. 17, 2001, comprises an evacuating portion including a first space defined by a bottom wall and sidewalls vertically extending from the edges of the bottom wall so as to accommodate a pet therein, a lid including a second space defined by a bottom wall and sidewalls vertically extending from edges of the bottom wall and with toilet paper contained therein and being connected to the evacuating portion in a foldable manner so as to cover the evacuating portion, a releasable locking means for keeping a state where the lid covers the evacuating portion, and an open-state maintaining means for keeping a state where the lid is opened with respect to the evacuating portion.

The pet potty constructed as above has no technical features other than that the pet potty is made in the form of a bag which can be carried along. The pet potty has a space for containing toilet paper therein and has an attractive appearance so that it may be carried during travel. Below, some problems of the prior art will be discussed.

First, even though the prior pet potty has an improved appearance, it is still inefficient from a practical point of view. That is, when the pet enters the evacuating portion and evacuates excrement on toilet paper placed therein by the owner, the owner then has to dispose of the excrement by replacing the toilet paper or by washing out the evacuating portion. Therefore, it is very inconvenience for the owner to perform such a procedure whenever the pet evacuates excrement during travel or at home.

Second, when the lid is not covered over the evacuating portion, the urine of feces discharged by a pet is exposed to the outside to release bad smell and cause unattractive visual effects.

Third, since a pet enters the evacuating portion and evacuates excrement therein, legs or other portions of the body of the pet are apt to be stained with the excrement.

As described above, the pet potty of the prior art has serious problems in actual use. Basically, the pet potty not only has a complicated structure but also has many disadvantages that hinder practical use of the item.

### SUMMARY OF INVENTION

The present invention was conceived to solve the aforementioned problems. An object of the present invention is to provide a pet potty which can conveniently and easily dispose of excrement of a pet and be used mainly in a home but conveniently carried along. Once the pet potty is placed at a predetermined location such as a living room, when the pet evacuates excrement on the potty, the excrement is then automatically received within the potty. Then the owner of the pet only has to wash the potty at a regular time interval, whereby the excrement of the pet can be easily and automatically disposed of.

In order to achieve the object of the present invention, the present invention provides a pet potty, comprising a frame which has a plurality of coupling recesses formed at an inner periphery defining an open central portion of the frame, and a driving motor installed in the frame to be driven by electric power from a power source; a plurality of floor members each of which has coupling bars formed at both sides thereof to be pivotally coupled to the respective coupling recesses; a driving mechanism installed within a portion of at least one side of the frame so as to rotate the floor members by means of a manual operation or the driving motor; an excrement tray detachably installed below the frame and the floor members; and a sensor installed in the frame to detect a pet. If the sensor detects stay of the pet over the frame for a predetermined period of time, the driving motor runs to rotate the floor members. Preferably, the frame is formed with a plurality of vents through which ozone and negative ions are generated, and a dust collecting plate is installed at the inside of the vents.

### BRIEF DESCRIPTION OF DRAWINGS

The above and other objects and features of the present invention will become apparent from the following description of preferred embodiments given in conjunction with the accompanying drawings, in which:

FIG. 1 is an exploded perspective view of a pet potty according to the present invention;

FIG. 2 is an assembled perspective view of the pet potty according to the present invention;

FIG. 3 is a perspective view of a pet potty according to another embodiment of the present invention;

FIG. 4 is a sectional view showing an operating state of the pet potty according to the present invention;

FIG. 5 is a perspective view of a pet potty according to a further embodiment of the present invention;

FIG. 6 is a sectional view of a portion of the pet potty of FIG. 5;

FIG. 7 is a perspective view of a pet potty according to a still further embodiment of the present invention;

FIG. 8 is a sectional view of a portion of the pet potty of FIG. 7;

FIG. 9 is a front view showing rotation of one of floor members of the pet potty according to the present invention;

FIG. 10 is a perspective view of a pet potty according to a still further embodiment of the present invention;

FIG. 11 is an exploded perspective view of the pet potty of FIG. 10;

FIG. 12 is a front view of the pet potty of FIG. 10;

FIG. 13 is a sectional view showing a state where the floor members are opened during the operation of the pet potty of FIG. 10; and

FIG. 14 is a sectional view showing a state where the floor members are closed during the operation of the pet potty of FIG. 10.

### DETAILED DESCRIPTION OF THE PREFERRED EMBODIMENT

Hereinafter, preferred embodiments of a pet potty of the present invention will be described in detail with reference to the accompanying drawings.

### Embodiment 1

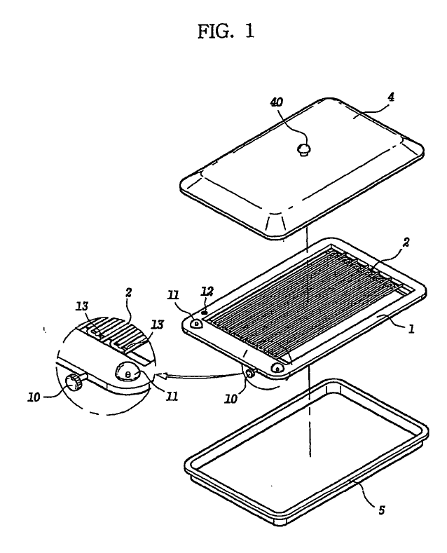

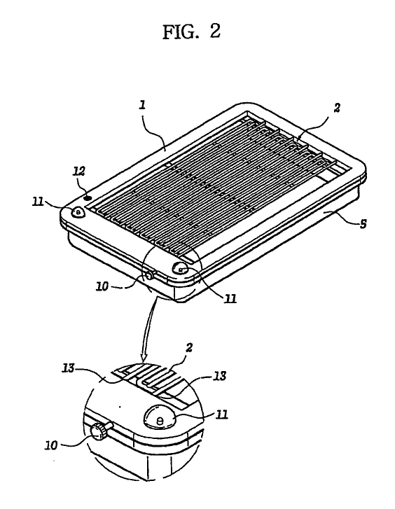

FIG. 1 is an exploded perspective view of a pet potty according to one preferred embodiment of the present invention, FIG. 2 is an assembled perspective view of the pet potty according to the present invention, FIG. 4 is a sectional view showing an operating state of the pet potty according the present invention, and FIG. 9 is a front view showing the rotation of one of the floor members in the pet potty according to the present invention.

A frame, designated by reference numeral 1, is formed with a rotary knob 10 at one side. As will be described below, the rotary knob 10 is used to manually rotate a plurality of floor members 2 covering the central opening of the frame 1. Preferably, a couple of sensors 11 running on electric power are installed at two corners of the frame. The sensors are used to detect the existence of a pet on the frame. Within the scope of the present invention, any types of sensors which may detect a pet staying on the frame may be used. For instance, an infrared sensor, a ultrasonic sensor, an RF sensor, a weight sensor and any other types of sensors may be effectively used to detect a pet over the potty. Even though this embodiment uses two sensors installed at two corners of the frame, the number and location of the sensors may vary within the scope of the present invention according to the type of the sensor being used.

Preferably, a melody speaker 12 is installed to the frame. The melody speaker 12 is used to notify the owner when a pet has left the potty after evacuation. Furthermore, a plurality of coupling recesses 13 are formed at opposite sides of an inner periphery of the frame 1, and a motor 14 running on the electric power from the power supply is installed at one side of the interior of the frame.

In the central opening of the frame 1 defined by the inner periphery of the frame, a plurality of floor members 2 are installed. Preferably, as shown in the figures, each floor member has a structure of a grate. Thus, when a pet discharges urine and feces on the floor member 1, urine may pass through the floor member while feces remains on the floor member. A plurality of floor members cover entire area of the central opening in a fashion that a plurality of blind blades cover a window. From longitudinal ends of each floor member, a pair of coupling bars are extended. The coupling bars are coupled into the respective coupling recesses 13 formed in the frame. The structure of the floor member is generally identical to each other in the following embodiments unless mentioned otherwise.

A gear 20 is integrally formed at the end of each coupling bar. A driving mechanism, designated by reference numeral 3, is configured in such a manner that one of the gears 20 formed at the end of the coupling bar is engaged with the motor 14 such that the gear can be rotated by an angle preferably within a range of 90 to 360 degrees. The rotation angle of the floor member may be freely selected within the above range in view of the design consideration. Further, a gear 20 is engaged with a rotary gear 100 formed at an end of the rotary knob 10. A plurality of idle gears 30 are alternately disposed between the adjacent gears 20 and engaged with the adjacent gears so that all the gears 30 can be rotated at a time by driving the motor 14 or turning the knob 10. It is manifest to a person of ordinary skill in the art that the floor members may be rotated by using various driving mechanism such as rack and pinion, timing gear and belt, driving chain and the like.

When power is supplied, the motor 14 runs to drive any one of the gears 20 engaged with the motor 14 and then to cause the floor members 2 to rotate by an angle within a range of 90 to 360 degrees since the idle gears 30 and the other gears 20 are sequentially engaged with one another. On the other hand, when the rotary knob 10 is manually rotated, the rotary gear 100 is first rotated and other gears 20 engaged with the rotary gear 100 are then rotated. Consequently, the sequentially engaged gears 20 and the idle gears 30 engaged therewith are also rotated, and thus, the floor member 2 can be rotated by a predetermined angle within a range of 90 to 360 degrees.

A lid, designated by reference numeral 4, is put on the top of the frame 1 and is formed with a grip 40 at the center thereof. The lid 4 is used to prevent a bad smell of excrement of the pet from being emitted to the outside and to present a beautiful external appearance.

An excrement tray, designated by reference numeral 5, is detachably mounted to the bottom of the frame 1 and the floor members 2. Preferably, an absorbent pad or the like is laid onto a floor surface of the excrement tray 5 so that the excrement of the pet does not come into direct contact with the floor surface of the excrement tray 5. Further, in a case where the absorbent pad is laid onto the floor surface, only the pad may be simply replaced with a new pad without handling the excrement tray 5 when a user intends to dispose of the excrement of the pet.

An operation of the pet potty according to the preferred embodiment of the present invention constructed as above will be hereinafter described.

First, if the electric power is supplied to the potty of the present invention, the sensors 11 installed at the frame 1 detect whether the pet approaches the potty to evacuate excrement. The sensors 11 also detects whether the pet leaves the potty after evacuating excrement on the floor members 2. After a certain period of time has passed since then, the motor 14 is actuated. Thus, the gear 20 connected to the motor 14 is first operated, and then, the other gears 20 are also operated by means of the idle gears 30. Consequently, the floor members 2 integrally formed with the gears 20 are rotated.

In such a state, the floor members 2 with the gears 20 integrally attached to their ends are automatically rotated. Thus, the feces of the pet remaining on the grate type floor member 2 also falls down into the excrement tray 5, and then, the floor members 2 are returned to their initial positions after a predetermined period of time. If the floor members are rotated by 360 degrees, it is not necessary to return the floor members to their initial position.

When the electric power cannot be supplied or during travel, the present invention will be utilized in the following manner.

If the owner of the pet rotates the rotary knob 10 formed at one side of the frame 1 after the pet has evacuated excrement, the rotary gear 100 formed at the end of the rotary knob 10 is also rotated. Thus, the gears 20 and the idle gears 30, which are engaged with the rotary gear 100, are sequentially rotated, and the floor members 2 integrally formed with the gears 20 are also rotated through 90 to 180 degrees. Therefore, the excrement of the pet automatically falls down into the excrement tray 5, and then, the owner rotates the rotary knob 10 in a reverse direction to return the floor members 2 to their initial positions.

### Embodiment 2

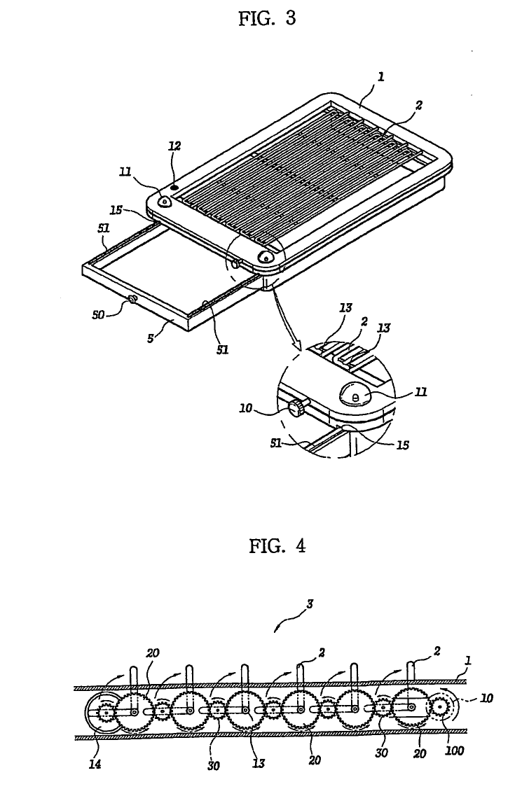

FIG. 3 is a perspective view of a pet potty according to another embodiment of the present invention. The present embodiment shown in FIG. 3 has the same constitution as Embodiment 1 except that rails 15 are formed on both sides of a bottom surface of the frame 1; ledges 51 corresponding to the rails 15 are formed longitudinally along lateral edges of the excrement tray 5 so that the excrement tray 5 can be slid along the rails 15; and a grip 50 is also formed at the center of one external surface of the excrement tray 5.

Accordingly, the present embodiment is substantially the same as Embodiment 1 in view of their operation. However, they are somewhat different from each other in a way how to dispose of the excrement of the pet. That is, Embodiment 1 is configured such that the frame 1 is first lifted from the excrement tray 5 and the excrement of the pet is then disposed of from the excrement tray 5, whereas Embodiment 2 is configured such that an action of pulling the grip 50 causes the excrement tray 5 to be removed from the frame 1 in a state where the ledges 51 are slid along the rails 15.

### Embodiment 3

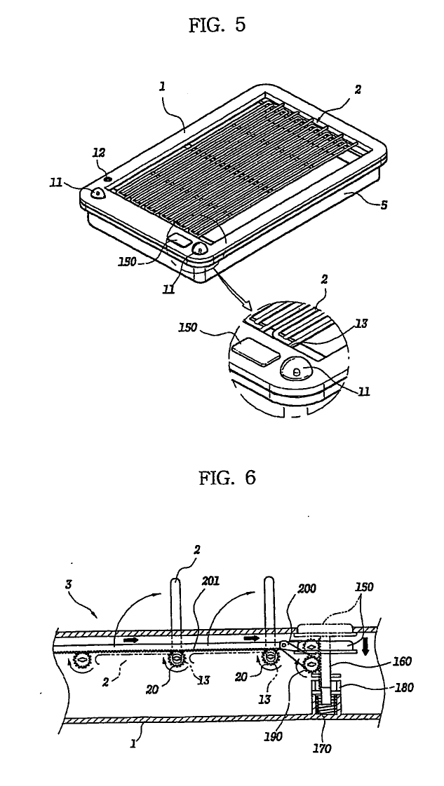

FIG. 5 is a perspective view of a pet potty according to a further embodiment of the present invention, and FIG. 6 is a sectional view of the pet potty of FIG. 5.

In the present embodiment, the motor 14, the idle gears 30 and the rotary gear 100 used in Embodiment 1 are not employed, and the following constitution is employed as an alternative of the manual driving mechanism 3. The alternative mechanism will be discussed below.

A push plate 150 is formed on the top surface of the frame 1. A rack 160 is formed on a lower portion of the push plate 150, and a housing 180 with a spring 170 installed therein is also formed at a lower portion of the rack 160. A pinion 190 is formed at one side of the rack 160 and fixed to one end of a rotary bar 200. The other end of the rotary bar 200 is also fixed to a guide rack 201 which is in turn engaged with the gears 20.

The operation of the pet potty according to the present embodiment constructed as above will be explained.

First, a melody speaker 12 optionally provided at the frame generates a melody when a pet leave the potty after evacuating excrement. In such a case, a battery not shown in the figures should be additionally provided for producing the melody from the speaker. However, since the battery has been well known in the art, it will not be further described in this embodiment.

If the owner of the pet presses down the push plate 150 under these circumstances, the spring 170 resiliently supported within the housing 180 is compressed and the pinion 190 engaged with the rack 160 is rotated on the rack 160. Then, the guide rack 201 fixed to the other side of the rotary bar 200 is slid rightward as viewed from the figure. Thus, the gears 20, which are formed at the ends of the floor members 2 and engaged with the guide rack 201, are rotated to allow the floor member 2 to rotate by a predetermined angle within a range of 90 to 360 degrees.

Accordingly, the excrement of the pet placed on the floor members 2 falls down into the excrement tray 5. Further, in order to return the floor members 2 to their initial positions, the aforementioned operation should be simply performed in the reverse manner.

### Embodiment 4

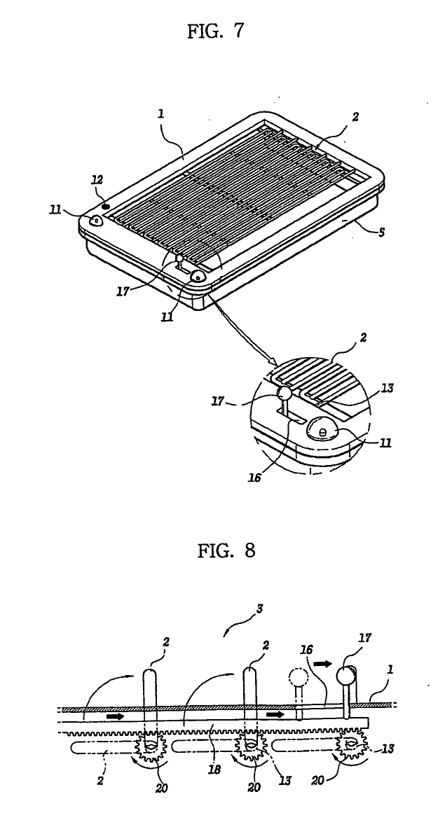

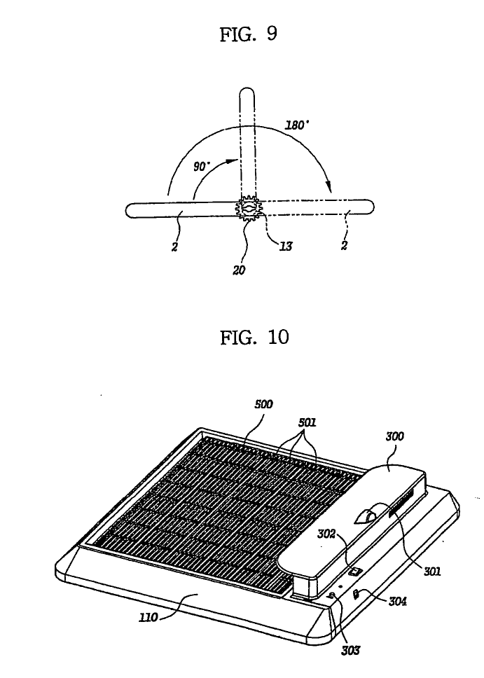

FIG. 7 is a perspective view of a pet potty according to a still further embodiment of the present invention, and FIG. 8 is a sectional view of a portion of the pet potty of FIG. 7.

The present embodiment is different from Embodiment 3 in terms of the constitution of the manual driving mechanism 3. The constitution of the driving mechanism according to the present embodiment will be discussed below.

A slot 16 is formed or cut out on one side of the top surface of the frame 1. A moving lever 17 is inserted in the slot 16, and a movable rack 18 is also formed at a distal end of the moving lever 17. Further, the gears 20 attached to the ends of the plurality of floor members 2 are engaged with the movable rack 18.

The operation of the pet potty according to the present embodiment constructed as above will be explained.

First, a melody speaker 12 optionally provided at the frame generates a melody when a pet leave the potty after evacuating excrement. In such a case, a battery not shown in the figures should be additionally provided for producing the melody from the speaker. However, since the battery has been well known in the art, it will not be further described in this embodiment.

If the owner of the pet shifts the moving lever 17 rightward as shown in FIG. 8, the movable rack 18 integrally formed at the end of the moving lever 17 is shifted rightward. Thus, the gears 20, which are formed at the ends of the floor members 2 and engaged with the movable rack 18, are rotated to allow the floor members 2 to rotate by a predetermined angle within a range of 90 to 360 degrees. Accordingly, the excrement of the pet placed on the floor members 2 falls down into the excrement tray 5. Further, in order to return the floor members 2 to their own initial positions, the aforementioned operation should be simply performed in the reverse manner.

### Embodiment 5

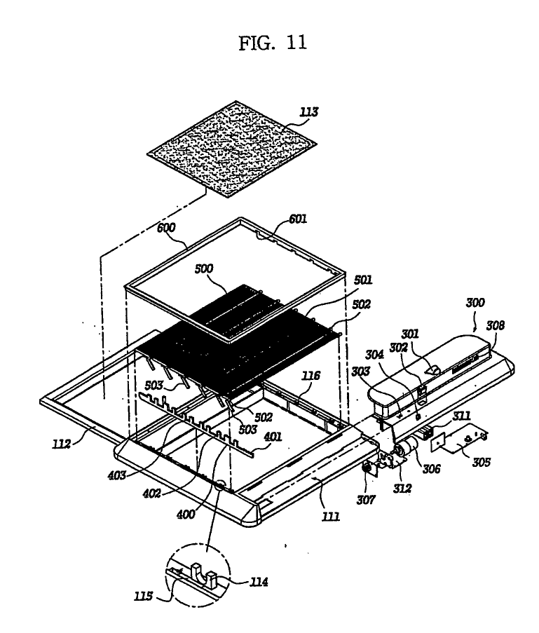

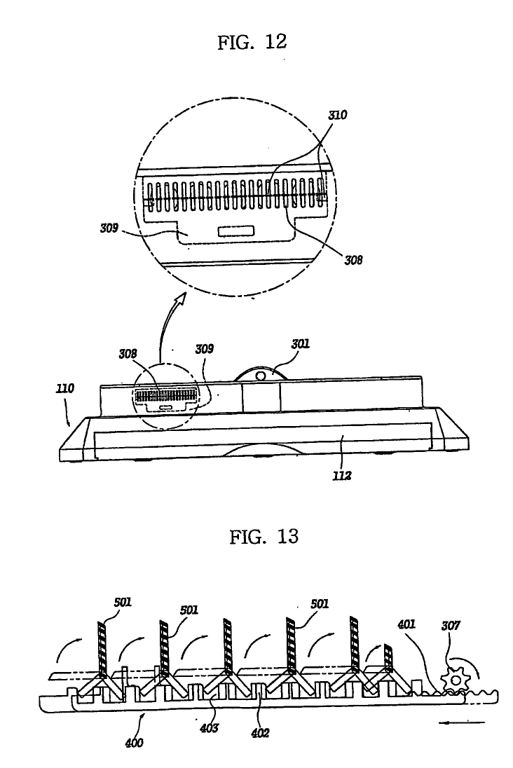

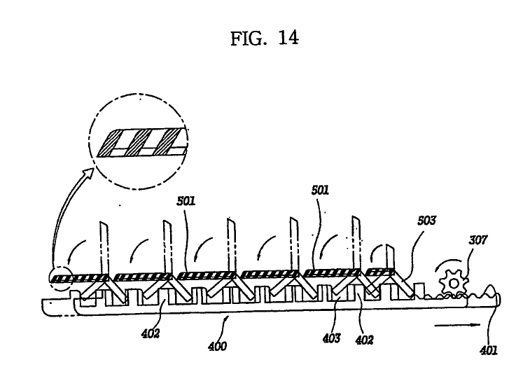

FIG. 10 is a perspective view of a pet potty according to a still further embodiment of the present invention, FIG. 11 is an exploded perspective of the pet potty of FIG. 10, FIG. 12 is a front view of the pet potty of FIG. 10, FIG. 13 is a sectional view showing a state where the floor members are opened during the operation of the pet potty of FIG. 10, and FIG. 14 is a sectional view showing a state where the floor members are closed during the operation of the pet potty of FIG. 10.

The present embodiment is different from the aforementioned embodiments in the following points that will be hereinafter described in detail.

Preferably a frame 110 has a rectangular shape. The frame is configured in such a manner that a coupling portion 111 is formed at one side of the frame and a slidable excrement tray 112 is provided at the opposite side thereof. Further, an optional absorbing pad 113 having excellent water absorbency is detachably installed on a floor surface of the excrement tray 112.

Furthermore, a plurality of semicircular insertion recesses 114 are formed on another side of the frame and elongated guide insertion slots 115 are also formed inside the semicircular insertion recesses 114. Semicircular insertion recesses 116 identical to the insertion recesses 114 are also formed on the opposite side thereof.

A control unit, designated by reference numeral 300, is inserted and coupled into the coupling portion 111 formed on the frame 110. A sensor 301 for detecting a pet is provided at the control unit. The sensor may be any type of sensor which may efficiently detects a pet. In the present embodiment, an infrared sensor is preferably used. However, an RF sensor, an acoustic (ultrasonic) sensor, a weight detector and the like may be used within the scope of the invention. Also it should be noted that the sensor may be installed at any proper location in the potty that is adequate to detect a pet staying on The frame 110. A power switch 302, a reset button 303, and a power supply terminal 304 are provided at the control unit. Further, a control board 305, a reversible motor 306, and a motor bracket 312 are sequentially installed within the control unit. In addition, a guide gear 307 is connected to the reversible motor 306.

Preferably, a plurality of vents 308 through which ozone and negative ions are generated are formed on at least on side of the control unit. An optional dust collecting plate 309 is also installed within the control unit so that the air passing through the vents 308 may be filtered thereby. The ozone is used to kill the bacteria and virus by its strong sterilizing power. That is, the ozone can exterminate harmful germs contained in the excrement of the pet and also remove the bad smell emitted from the excrement. The ozone and the negative ions are discharged through the vents 308.

More specifically, when the electric power is applied, negative voltage is applied to a negative electrode pin 301. Then, negative electrons having high energy sufficient to cause ionization are discharged at a high speed from an end of the sharp negative electrode pin 310. The electrons discharged from the electrode pin 310 collide against molecules entrained with air, and thus, the negative ions are generated and discharged through the vents 308. The dust collecting plate 309 serves to collect introduced fine dusts and also to absorb the bad smell of the excrement.

A guide bar, designated by reference numeral 400, is inserted into the guide insertion slots 115 and is provided with a rack 401 so that the guide bar can be engaged with the guide gear 307. A plurality of moving protrusions 402 are also formed in the guide bar.

Floor members, collectively designated by reference numeral 500, are formed to have numerous holes perforated thereon. Preferably, each individual floor member 501 has a grate-type structure. Preferably, the cross section of the floor member has of shape as shown in FIG. 14 in order to render the inside of the potty invisible. Preferably, the floor member 501 may be made of a variety of materials such as synthetic resin, metal, and the like. Each of the floor members is formed with pivot bars 502 at both sides thereof such that the floor member can be pivoted on the pivot bars 502 inserted into the insertion recesses 114 and 116.

Meanwhile, the pivot bar 502 at one side of each of the floor members is formed integrally with an inclined moving bar 503 to be inserted into one of moving recesses 403 naturally defined between the adjacent moving protrusions 402.

A coupling frame, designated by reference numeral 600, is coupled on the top of the plurality of floor members 500 and is formed with semicircular recesses 601 at the bottom thereof to define circles in cooperation with the insertion recesses 114 and 116. The coupling frame 600 is used to prevent the escape of the floor members 500 even when the pet potty is inadvertently turned over by the pet.

Reference numeral 311 that has not yet been explained designates a battery used when the pet potty is intended to be used at a place where supply of electric power is not available.

The operation of the pet potty of the present embodiment will be described hereinafter.

The control unit 300 is first manipulated to set periods of time for determining whether the pet discharged feces or urine while it was staying on the floor member 500 of the pet potty. That is, if the pet stayed a shorter period of time on the potty, it is deemed that the pet has discharged urine. On the other hand, it the pet stayed a longer period of time, the pet is deemed to have discharged feces. If a pet comes onto the floor member 500 in order to urinate, it will stay on the floor member 500 for a relatively short period of time. If the duration of the stay detected by the sensor 301 is shorter than a predetermined threshold, the control unit 300 does not perform any operation after the pet left the floor member 500, and let the urine fall down into the excrement tray 112. At this time, since the floor member 500 is constructed to have a grate structure, any additional operation is not required to remove urine from the surface of the floor member 500. The threshold may be properly set by observing the evacuation habits of various sorts of pets.

On the other hand, in a case where the pet stays on the floor member 500 for a period of time longer than a predetermined threshold, it is deemed that the pet has discharged feces. Then, the reversible motor 306 is driven and the guide gear 307 coupled to the shaft of the reversible motor 306 is rotated after the pet left the floor member. If the guide gear 307 begins to rotate from its stationary state, the rack 401 that is formed at the leading end of the guide bar 400 and engaged with the guide gear 307 moves back and forth. This causes the guide bar 400 to move back and forth. As the guide bar 400 moves back and forth, as shown in FIG. 13, after the pet evacuated feces and left the floor member 500, the reversible motor 306 is rotated in the clockwise direction for a predetermined period of time or through a predetermined angle and the guide gear 307 is then rotated in the same clockwise direction for a predetermined period of time or through a predetermined angle so that the guide bar 400 moves leftward accordingly. When the guide bar 400 moves leftward in such a manner, the moving bars 503 move leftward and the pivot bars 502 formed integrally with the moving bars 503 are pivoted so that the horizontal floor member 501 can be placed in a vertical posture. At this time, the feces of the pet placed on the floor member 501 falls down into the excrement tray 112. Thereafter, as shown in FIG. 14, the reversible motor 306 is rotated in the counterclockwise direction for a predetermined period of time or through a predetermined angle and the guide gear 307 is then rotated in the same counterclockwise direction for a predetermined period of time or through a predetermined angle so that the guide bar 400 moves rightward accordingly. When the guide bar 400 moves rightward in such a manner, the moving bars 503 move rightward and the pivot bars 502 formed integrally with the moving bars 503 are pivoted so that the vertical floor members 501 can be placed in a horizontal posture. Thus, the floor member 500 is in a position that allows a pet to come onto the floor member for next use. Although the mechanism used to rotate the floor member is explained referring to a specific example, the driving mechanism may be changed and altered in various manner within the scope of the present invention. Some examples of the changes and alterations have been explained with respect to previous embodiments.

In connection with the basic operation described above, it is more preferred that a bad smell emitted from the excrement of the pet be deodorized by ozone and negative ions generated through the vents 308 preferably formed in the control unit 300. This uses a property of negative ions that they are heavier than air. The negative ions generated through the vents 308 move toward the floor member 500 and then deodorize the bad smell emitted from the excrement of the pet. The dust collecting plate 309 is provided at the inside of the vents 308 to collect fine dust and deodorize the bad smell entrained with air.

Although the present invention has been described and illustrated by way of example in connection with the specific preferred embodiments of the present invention, the present invention is not limited thereto. It will be understood that those skilled in the art can make various modifications and changes thereto without departing from the technical spirit and scope of the invention defined by the appended claims.

### INDUSTRIAL APPLICABILITY

According to the present invention constructed as above, the excrement of the pet can be conveniently and easily disposed of. Since a melody is generated by the melody speaker as the pet finishes evacuating excrement regardless of whether or not electric power is supplied to the pet potty, the owner of the pet does not have to follow the pet whenever the pet evacuates excrement. Particularly, even upon interruption of electric power, the excrement of the pet can be easily and conveniently disposed of by manual operation of the push plate, moving lever or rotary knob. In addition, the pet potty of the present invention can be automatically operated by determining whether the pet discharged urine or feces based on the time during which the pet stayed on the potty and detected by the sensor. Furthermore, since the plurality of vents are formed in the frame of the potty and negative ions are generated through the vents, the bad smell emitted from the excrement of the pet can be deodorized by the negative ions. Moreover, the dust collecting plate is provided at the inside of the vents so as to collect and deodorize the fine dust and the bad smell entrained with air.

1. A pet potty, comprising:
a frame having a plurality of coupling recesses formed at an inner periphery defining an open central portion of the frame, and a driving motor installed in the frame to be driven by electric power from a power source;
a plurality of floor members each of which has coupling bars formed at both sides thereof, the coupling bars being pivotally coupled to the respective coupling recesses;
a driving mechanism installed within a portion of at least one side of the frame so as to rotate the floor members by means of a manual operation or the driving motor;
an excrement tray detachably installed below the frame and the floor members; and
a sensor installed in the frame to detect a pet,
wherein if the sensor detects stay of the pet on the frame for a predetermined period of time, the driving motor runs to rotate the floor members.

2. The pet potty as claimed in claim 1, wherein a gear is mounted on the coupling bar at one side of each of the floor members, and the driving mechanism includes a plurality of idle gears alternately engaged with the gears of the plurality of the floor members so as to rotate the plurality of floor members at a time.

3. The pet potty as claimed in claim 1, wherein a gear is mounted on the coupling bar at one side of each of the floor members, and the driving mechanism includes a rack engaged with the gears of the plurality of the floor members so as to rotate the plurality of floor members at a time.

4. The pet potty as claimed in claim 2, wherein the driving mechanism rotates the floor members by an angle within a range of 90 to 360 degrees.

5. The pet potty as claimed in claim 1, wherein a melody speaker is provided at the frame.

6. The pet potty as claimed in claim 1, wherein the sensor is selected from a group comprising an acoustic sensor, an infrared sensor, a weight detector and an RF sensor.

7. The pet potty as claimed in claim 1, wherein a pivot bar is formed on at least one side of each of the floor members such that the pivot bar extends at a predetermined angle with respect to a surface of each of the floor members, and the driving mechanism includes a guide bar that is coupled to the driving motor by means of a rack and pinion structure and formed with a plurality of protrusions, whereby the pivot bars are engaged with the protrusions of the guide bar and translation of the guide bar causes the floor members to rotate.

8. The pet potty as claimed in claim 1, wherein the frame is formed with a plurality of vents through which ozone and negative ions are generated, and a dust collecting plate is installed at the inside of the vents.

9. The pet potty as claimed in claim 1, wherein a control unit is mounted on the frame, and the control unit is provided with a power switch, a reset button and a power supply terminal at the exterior thereof and with a control board, a reversible motor and a motor bracket sequentially installed at the interior thereof.

10. The pet potty as claimed in claim 1, wherein each of the floor members has a grate structure.

11. The pet potty as claimed in claim 1, wherein the frame comprises a lower frame to which the excrement tray is slidably mounted and the driving mechanism is installed, and a coupling frame coupled to the lower frame so as to define the coupling recesses in which the coupling bars of the floor members are inserted.

12. The pet potty as claimed in claim 3, wherein the driving mechanism rotates the floor members by an angle within a range of 90 to 360 degrees.
